(19) United States
(12) Patent Application Publication
(10) Pub. No.: US 2023/0316012 A1
(43) Pub. Date: Oct. 5, 2023

(54) WIRELESS TAG READING DEVICE AND COMPUTER-READABLE STORAGE MEDIUM

(71) Applicant: Toshiba Tec Kabushiki Kaisha, Tokyo (JP)

(72) Inventors: Sayaka SHIMOKAWA, Yokohama Kanagawa (JP); Hiroyuki YAMAGUCHI, Yokohama Kanagawa (JP); Ran KATSURADA, Shinagawa Tokyo (JP); Yuki FURUKAWA, Ichikawa Chiba (JP); Yohei YANASE, Arakawa Tokyo (JP); Katsutoshi WATANABE, Tama Tokyo (JP)

(21) Appl. No.: 18/206,440

(22) Filed: Jun. 6, 2023

Related U.S. Application Data
(63) Continuation of application No. PCT/JP2022/001170, filed on Jan. 14, 2022.

(30) Foreign Application Priority Data
Feb. 22, 2021 (JP) 2021-026728

(51) Int. Cl. G06K 7/10

(52) U.S. Cl. CPC G06K 7/10019

(57) ABSTRACT

A wireless tag reading device includes a processor, wherein the processor is configured to: receive one or more pieces of type information, each indicating a type of an article as a search target; read, from a wireless tag storing a piece of type information, the piece of type information; display a position of the wireless tag when the piece of type information read is identical to any of the one or more pieces of type information received; and exclude the wireless tag whose position has been displayed from a display target.

### CROSS-REFERENCE TO RELATED APPLICATIONS

This application is a continuation application of International Application No. PCT/JP2022/001170, filed Jan. 14, 2022, which designates the United States, and which claims the benefit of priority from Japanese Patent Application No. 2021-026728, filed Feb. 22, 2021, the entire contents of which are incorporated herein by reference.

### FIELD

Embodiments described herein relate generally to a wireless tag reading device and a computer-readable storage medium.

### BACKGROUND

Conventionally, there has been a disclosed system that searches for a desired article by reading identification information from a wireless tag attached to the article. Such a system sets identification information desired to be searched in advance and thereby searches for the desired article.

However, the conventional system needs to set the number of pieces of identification information to be searched even when searching for a plurality of articles of the same type, and this has required much time and effort.

It is thus preferable to provide a wireless tag reading device and a program capable of reducing time and effort required for searching for an article using a wireless tag.

### BRIEF DESCRIPTION OF DRAWINGS

FIG. 1 is a diagram illustrating an example of an article management system according to the present embodiment.

FIG. 2 is a block diagram illustrating an example of a hardware configuration of a wireless tag reading device.

FIG. 3 is a block diagram illustrating an example of a functional configuration of a wireless tag reading device according to the present embodiment.

FIG. 4 is a diagram illustrating an example of an input screen.

FIG. 5 is a diagram illustrating an example of a search screen.

FIG. 6 is a diagram illustrating an example of a search list screen.

FIG. 7 is a flowchart illustrating an example of search processing executed by a wireless tag reading device according to the embodiment.

### DETAILED DESCRIPTION

According to one embodiment, a wireless tag reading device includes a processor, wherein the processor is configured to: receive one or more pieces of type information, each indicating a type of an article as a search target; read, from a wireless tag storing a piece of type information, the piece of type information; display a position of the wireless tag when the piece of type information read is identical to any of the one or more pieces of type information received; and exclude the wireless tag whose position has been displayed from a display target.

Hereinafter, embodiments of a wireless tag reading device and a program will be described in detail with reference to the accompanying drawings. Note that the embodiment described below is an embodiment of a wireless tag reading device and a program, and does not limit their configurations, specifications, or the like.

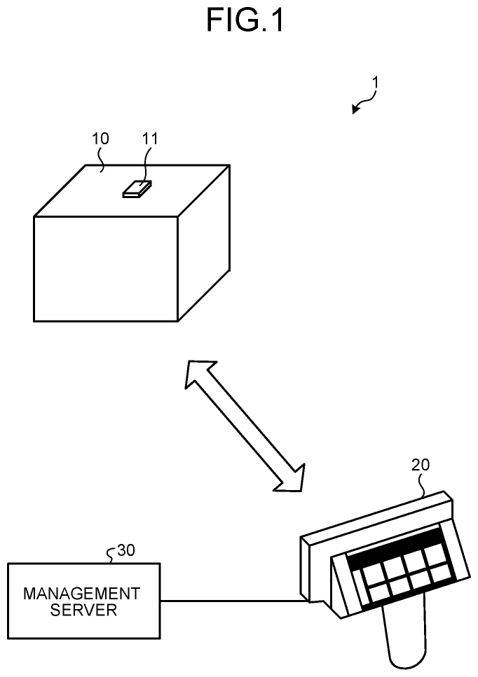

FIG. 1 is a diagram illustrating an example of an article management system 1 according to the present embodiment. The article management system 1 is a system that manages articles 10 stored in a warehouse or the like. For example, the article management system 1 is an inventory management system that manages the quantity of articles 10 and the like.

The article management system 1 includes a wireless tag 11 attached to the article 10, a wireless tag reading device 20, and a management server 30. The wireless tag reading device 20 and the management server 30 are communicably connected with each other in a wired or wireless communication. In addition, the article management system 1 illustrated in FIG. 1 includes one wireless tag 11 attached to the article 10, one wireless tag reading device 20, and one management server 30. However, the article management system 1 may include a plurality of the wireless tags 11 attached to the article 10, a plurality of the wireless tag reading devices 20, and a plurality of the management servers 30.

The article 10 is a management target of the article management system 1. For example, the article 10 is a product.

The wireless tag 11 is, for example, a tag such as an electronic tag, an IC tag, or an RF tag. Using near field communication, the wireless tag 11 transmits and receives information stored in a storage medium of the wireless tag 11. For example, the wireless tag 11 stores identification information in a storage medium. The identification information includes type information and individual information. The type information is information for identifying the type of the article 10 to which the wireless tag 11 is attached. For example, the type information is identification information for identifying a product, such as a Japan Article Number (JAN) code. The individual information is information for identifying individual articles 10 to each of which the wireless tag 11 is attached. For example, the individual information is information for identifying individual products, such as an electronic product code (EPC) and a serial number. Having received a radio wave to read identification information stored in the storage medium, the wireless tag 11 transmits identification information. In other words, the wireless tag 11 transmits a radio wave having identification information.

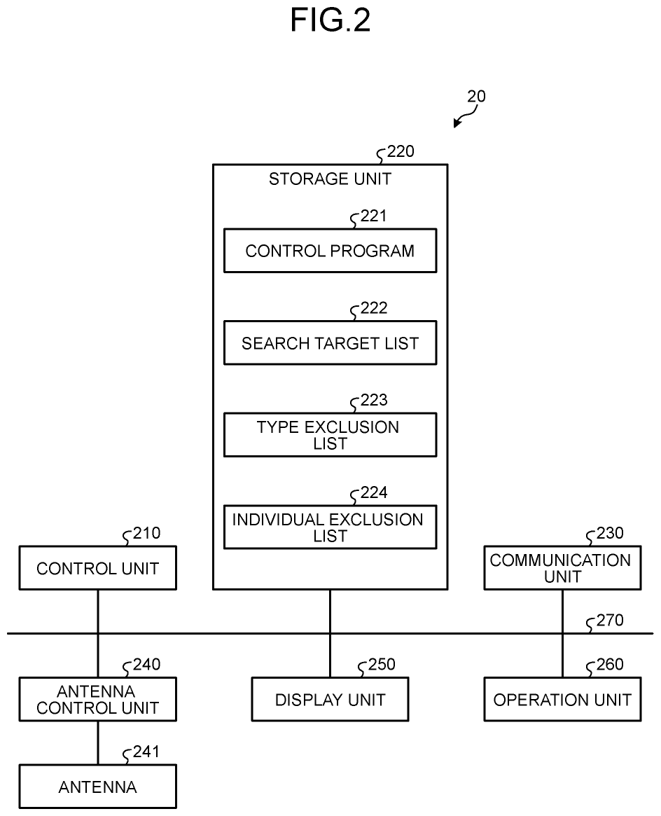

The wireless tag reading device 20 is a reading device that reads the storage medium of the wireless tag 11. For example, the wireless tag reading device 20 is a handheld reading device for the wireless tag 11, having a grip portion to be gripped by a user. The wireless tag reading device 20 reads the wireless tag 11 by transmitting and receiving a radio wave with an antenna 241 (refer to FIG. 2). That is, the wireless tag reading device 20 reads the wireless tag 11 in the radio wave transmission/reception direction of the antenna 241 directed by the user. The wireless tag reading device 20 receives an input for specifying the wireless tag 11 as a search target. The wireless tag reading device 20 emits a radio wave for reading the identification information stored in the storage medium of the wireless tag 11. When the radio wave is transmitted from the wireless tag 11, the wireless tag reading device 20 decodes the radio wave received from the wireless tag 11 to extract the identification information.

The wireless tag reading device 20 measures the distance and direction to the wireless tag 11 based on the radio wave received from the wireless tag 11. When having extracted identification information suitable for the search target, the wireless tag reading device 20 specifies that the radio wave carrying the extracted identification information has the highest field intensity. In other words, the wireless tag reading device 20 specifies the nearest wireless tag 11. The wireless tag reading device 20 displays the specified distance and direction to the wireless tag 11. This makes it possible for an operator to specify the position where the wireless tag 11 of the search target is disposed.

The management server 30 is a server device that stores various types of information regarding the article 10 as a management target.

Here, there is a case where the operator desires to search for a plurality of articles 10 of the same type. In this case, conventionally, when type information has been input as information for specifying the wireless tag 11 as a search target, the wireless tag reading device first displays a distance and a direction to the nearest wireless tag 11 storing the input identification information. Thereafter, here is a case where the wireless tag reading device searches for the wireless tag 11 attached to the next different article 10 as a search target. In a case where the operator discovers the article 10 as a search target that has already been discovered and when the discovered article 10 is the nearest one, the wireless tag reading device again displays the distance and direction to the wireless tag 11 attached to the discovered article 10. This makes it impossible for the operator to search for another piece of the article 10.

To handle this, the wireless tag reading device 20 receives an operation of excluding the displayed wireless tag 11 from the search target. The wireless tag reading device 20 stores the identification information of the wireless tag 11 read as the search target, in a type exclusion list 223 or an individual exclusion list 224. The wireless tag reading device 20 excludes the wireless tag 11 specified by the identification information stored in the type exclusion list 223 or the individual exclusion list 224 from the wireless tags 11 as subsequent search targets. This allows the discovered article 10 to be excluded from the search target, and thus, the wireless tag reading device 20 would not display the distance and direction to the wireless tag 11 attached to the discovered article 10 even when the once discovered article 10 is in the neighborhood. This makes it possible for the operator to search for another piece of the article 10. In addition, the wireless tag reading device 20 can reduce time and effort for searching for a plurality of articles 10 of the same type.

Next, a hardware configuration of the wireless tag reading device 20 will be described.

FIG. 2 is a block diagram illustrating an example of a hardware configuration of the wireless tag reading device 20. The wireless tag reading device 20 includes a control unit 210, a storage unit 220, a communication unit 230, an antenna control unit 240, a display unit 250, and an operation unit 260. These units are connected to each other via a system bus 270 such as a data bus or an address bus.

The control unit 210 is a computer that controls the overall operation of the wireless tag reading device 20 and implements various functions of the wireless tag reading device 20. The control unit 210 includes a central processing unit (CPU), read only memory (ROM), and random access memory (RAM). The CPU integrally controls operation of the wireless tag reading device 20. The ROM is a storage medium that stores various programs and data. The RAM is a storage medium that temporarily stores various programs and various data. That is, the control unit 210 includes: the CPU, which is an example of a processor; and the RAM, which is an example of memory communicably coupled to the CPU. The CPU executes a program stored in the ROM, the storage unit 220, or the like using the RAM as a work area.

The storage unit 220 is a storage device such as flash memory. The storage unit 220 stores a control program 221, a search target list 222, a type exclusion list 223, and an individual exclusion list 224. Note that the search target list 222, the type exclusion list 223, and the individual exclusion list 224 may be stored in another device, not limited to the wireless tag reading device 20.

The control program 221 is a program for exerting functions of an operating system and the wireless tag reading device 20. The control program 221 includes a program for exerting characteristic functions according to the present embodiment.

The search target list 222 is information including one or more pieces of type information indicating the type of the article 10 as a search target. The type exclusion list 223 is information including one or more pieces of type information to be excluded from the search target. The individual exclusion list 224 is information having one or more pieces of individual information to be excluded from the search target.

The communication unit 230 is an interface that executes communication with an external device. For example, the communication unit 230 executes communication with the management server 30 by mobile communication, a wireless local area network (LAN), or the like.

The antenna control unit 240 is connected to the antenna 241. The antenna control unit 240 controls the field intensity of the radio wave emitted from the antenna 241.

The antenna 241 is a device that transmits a radio wave to the wireless tag 11 or receives a radio wave emitted from the wireless tag 11. Furthermore, the antenna 241 perform mutual conversion between a current and a radio wave.

The display unit 250 is a display device that displays various screens. For example, the display unit 250 is a liquid crystal display.

The operation unit 260 is an input device that receives various operations. For example, the operation unit 260 may be a button provided in the wireless tag reading device 20, may be a touch pad or a touch panel provided in the display unit 250, or may be another device.

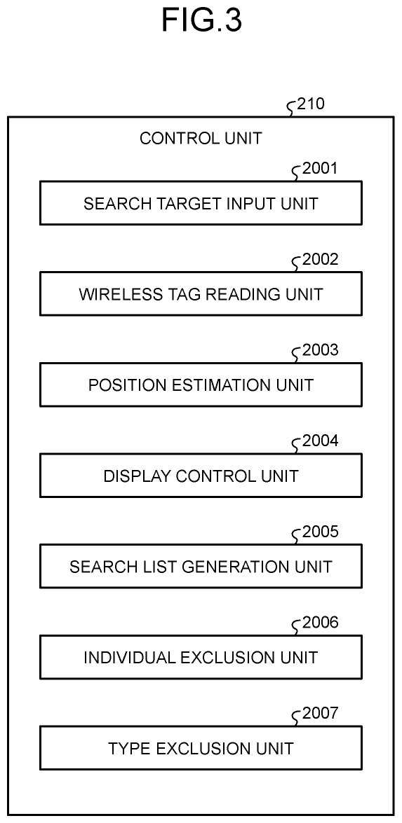

Next, functions of the wireless tag reading device 20 will be described. FIG. 3 is a block diagram illustrating an example of a functional configuration of the wireless tag reading device 20 according to the present embodiment.

The CPU included in the control unit 210 of the wireless tag reading device 20 develops the control program 221 stored in the storage unit 220 in the RAM and operates in accordance with the control program 221 to generate each functional unit in the RAM. With this configuration, the control unit 210 of the wireless tag reading device 20 includes, as functional units, a search target input unit 2001, a wireless tag reading unit 2002, a position estimation unit 2003, a display control unit 2004, a search list generation unit 2005, an individual exclusion unit 2006, and a type exclusion unit 2007. That is, the processor functions as a search target input unit 2001, a wireless tag reading unit 2002, a position estimation unit 2003, a display control unit 2004, a search list generation unit 2005, an individual exclusion unit 2006, and a type exclusion unit 2007. In addition, all or part of the search target input unit 2001, the wireless tag reading unit 2002, the position estimation unit 2003, the display control unit 2004, the search list generation unit 2005, the individual exclusion unit 2006, and the type exclusion unit 2007 may be implemented by hardware such as a semiconductor circuit.

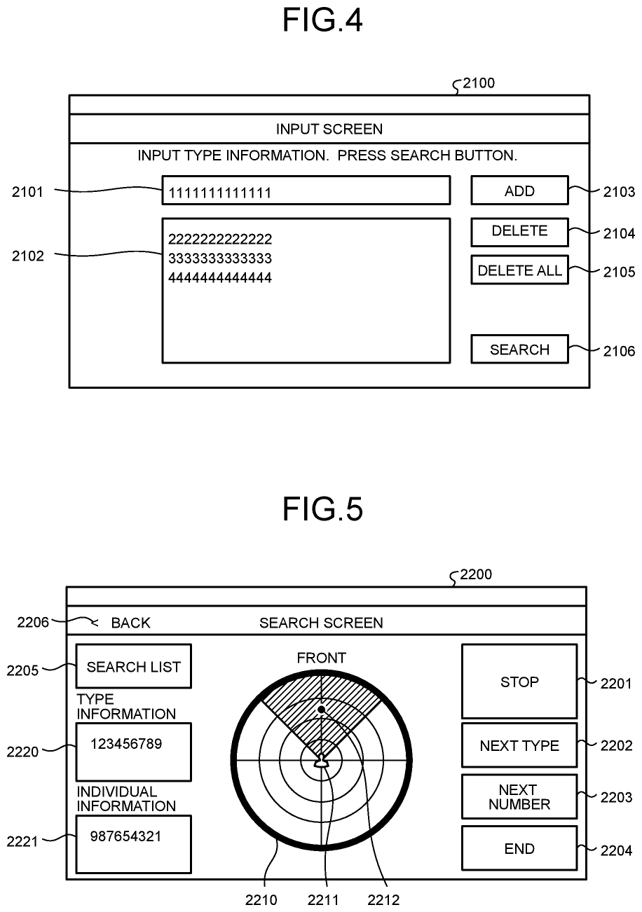

The search target input unit 2001 receives one or a plurality of pieces of type information indicating the type of the search target article 10. The search target input unit 2001 is an example of an input unit. For example, the search target input unit 2001 receives an input of type information indicating the type of the article 10 as a search target, on an input screen 2100 (refer to FIG. 4). Alternatively, the search target input unit 2001 may receive the name of the article 10 as a search target. In this case, the search target input unit 2001 acquires the type information corresponding to the name of the article 10 as the search target, from the management server 30. With this configuration, the search target input unit 2001 may receive an input of the type information.

The wireless tag reading unit 2002 reads the wireless tag 11 that stores type information. The wireless tag reading unit 2002 is an example of a reading unit. More specifically, the wireless tag reading unit 2002 controls the antenna control unit 240 to cause the antenna 241 to emit a radio wave for reading the wireless tag 11. The wireless tag reading unit 2002 also decodes the radio wave received by the antenna 241 to extract identification information. With this operation, the wireless tag reading unit 2002 reads the wireless tag 11 that stores the type information and the individual information for identifying the article 10.

Based on the radio wave carrying the identification information read from the wireless tag 11 by the wireless tag reading unit 2002, the position estimation unit 2003 estimates the position where the wireless tag 11 is disposed. More specifically, the position estimation unit 2003 estimates the distance from the wireless tag 11 to the wireless tag reading device 20 based on the field intensity of the radio wave carrying the identification information. Furthermore, the position estimation unit 2003 estimates the direction in which the wireless tag 11 is disposed based on the direction in which the radio wave carrying the identification information has been received and the direction of the antenna 241 directed when the radio wave carrying the identification information has been received.

The position estimation unit 2003 estimates whether the wireless tag 11 is disposed in the vicinity of the wireless tag reading device 20. In other words, the position estimation unit 2003 estimates whether the wireless tag 11 is disposed at a vicinity distance. The vicinity distance is a set distance. For example, when having read the wireless tag 11, the position estimation unit 2003 gradually reduces the power used by the antenna 241 for radio wave emission. When the identification information is successfully read from the wireless tag 11 when the radio wave is emitted to the antenna 241 with less power than the set power, the position estimation unit 2003 estimates that the wireless tag 11 is disposed at the vicinity distance.

The display control unit 2004 displays various screens on the display unit 250. For example, the display control unit 2004 controls to display the input screen 2100 that receives one or a plurality of pieces of type information indicating the type of the article 10 as a search target. FIG. 4 is a diagram illustrating an example of the input screen 2100. The input screen 2100 includes a type information input field 2101, a type information display field 2102, an add button 2103, a delete button 2104, a delete all button 2105, and a search button 2106. The type information input field 2101 is a field for inputting type information indicating the type of the article 10 as a search target. The type information display field 2102 is a field for displaying type information added as the type of the article 10 as a search target.

The add button 2103 is a button for adding the type information input in the type information input field 2101 as the type of the article 10 as a search target. The delete button 2104 is a button for deleting the type information added as the type of the article 10 as a search target. For example, the delete button 2104 receives an operation of deleting the type information selected in the type information display field 2102. The delete all button 2105 is a button for deleting all of the type information added as the type of the article 10 as a search target. For example, the delete button 2104 receives an operation of deleting all pieces of type information in the type information display field 2102. The search button 2106 is a button that receives an operation of ending input of type information indicating the type of the article 10 as a search target and starting a search for the wireless tag 11.

For example, the display control unit 2004 displays a search screen 2200 indicating the position of the wireless tag 11 that stores the same type information as the type information received by the search target input unit 2001 based on the reading result of the wireless tag 11 by the wireless tag reading unit 2002. The display control unit 2004 is an example of a first display unit. FIG. 5 is a diagram illustrating an example of the search screen 2200. The search screen 2200 includes a position display area 2210, a type information display area 2220, an individual information display area 2221, a stop button 2201, a next type button 2202, a next number button 2203, an end button 2204, a search list button 2205, and a back button 2206.

The position display area 2210 is an area for displaying the position of the wireless tag 11. The position display area 2210 displays a first mark 2211 indicating the position of the wireless tag reading device 20 and a second mark 2212 indicating the position of the wireless tag 11. The display control unit 2004 controls to display the second mark 2212 in the position display area 2210 based on the direction and distance in which the wireless tag 11 is disposed estimated by the position estimation unit 2003.

The display control unit 2004 selects identification information having the type information input on the input screen 2100 from among the pieces of identification information read from the wireless tag 11 by the wireless tag reading unit 2002. That is, the display control unit 2004 selects identification information having type information registered in the search target list 222. In addition, the display control unit 2004 excludes the identification information having the type information registered in the type exclusion list 223 and having the individual information registered in the individual exclusion list 224. In addition, from among the identification information remaining without being excluded, the display control unit 2004 specifies identification information having the highest field intensity of the radio wave carrying the identification information Subsequently, the display control unit 2004 controls to display the second mark 2212 at the position of the wireless tag 11 storing the specified identification information based on the estimation result of the position estimation unit 2003.

In this manner, the display control unit 2004 does not display the position of the wireless tag 11 storing the individual information registered in the individual exclusion list 224 by the individual exclusion unit 2006. In addition, the display control unit 2004 does not display the position of the wireless tag 11 storing the type information registered in the type exclusion list 223 by the type exclusion unit 2007. This makes it possible for the operator to search for a next piece of the article 10.

The type information display area 2220 is an area for displaying type information among the identification information read from the wireless tag 11 corresponding to the second mark 2212 displayed in the position display area 2210. In other words, the type information display area 2220 is an area for displaying the type information carried by the radio wave having the highest field intensity. The individual information display area 2221 is an area for displaying individual information among the identification information read from the wireless tag 11 corresponding to the second mark 2212 displayed in the position display area 2210. In other words, the individual information display area 2221 is an area for displaying the individual information carried by the radio wave having the highest field intensity.

The stop button 2201 is a button that receives an operation of stopping the search for the wireless tag 11. The next type button 2202 is a button that receives an operation of changing the type information of the wireless tag 11 as a display target of the position display area 2210, out of the identification information input on the input screen 2100, to the next type information. In other words, the next type button 2202 is a button that receives an operation of excluding the type information of the wireless tag 11 as a display target of the position display area 2210 from the search target. The next number button 2203 is a button that receives an operation of changing the individual information of the wireless tag 11 as a display target of the position display area 2210 out of the identification information input on the input screen 2100, to the next individual information. In other words, the next number button 2203 is a button that receives an operation of excluding the individual information of the wireless tag 11 as a display target of the position display area 2210 from the search target.

Here, at the beginning of displaying the search screen 2200, the display control unit 2004 displays the next type button 2202 and the next number button 2203 as non-selectable buttons by graying out the buttons or the like. There is a possibility that the operator of the wireless tag reading device 20 has not successfully discovered the wireless tag 11 when the distance to the wireless tag 11 is the vicinity distance or more. However, pressing the next number button 2203 would exclude the wireless tag 11 from the display target. In this case, the operator would fail in discovering the wireless tag 11. To handle this, the display control unit 2004 displays the next number button 2203 as a selectable button when the distance to the wireless tag 11 is less than the vicinity distance. That is, when it is estimated that the article 10 as a search target has been discovered, the display control unit 2004 displays the next number button 2203 as a selectable button. That is, when the distance to the wireless tag 11 at the position displayed by the display control unit 2004 is less than a threshold, the next number button 2203 receives the operation of excluding the wireless tag 11 from the display target. The next number button 2203 is an example of a first operation unit.

There is a case where the operator of the wireless tag reading device 20 desires to perform advance collection of the article 10 to which the wireless tag 11 of specific type information is attached, out of the type information input on the input screen 2100. In such a case, when the type information of the wireless tag 11 displayed in the position display area 2210 does not indicate the type of the article 10 desired to be obtained in the advance collection, the operator can collect the desired article 10 by excluding the displayed article from the display target at an early stage. Accordingly, when the position of the wireless tag 11 is displayed in the position display area 2210, the display control unit 2004 displays the next type button 2202 as a selectable button. That is, when the display control unit 2004 displays the position of the wireless tag 11, the next type button 2202 receives an operation of excluding the wireless tag 11 storing the same type information as the type information stored in the wireless tag 11 from the display target. The next type button 2202 is an example of a second operation unit.

The end button 2204 is a button that receives an operation to end the search for the wireless tag 11. The search list button 2205 is a button that receives an operation of controlling to display a list of the articles 10 to which the searched wireless tag 11 is attached. The back button 2206 is a button that receives an operation of controlling to display the input screen 2100.

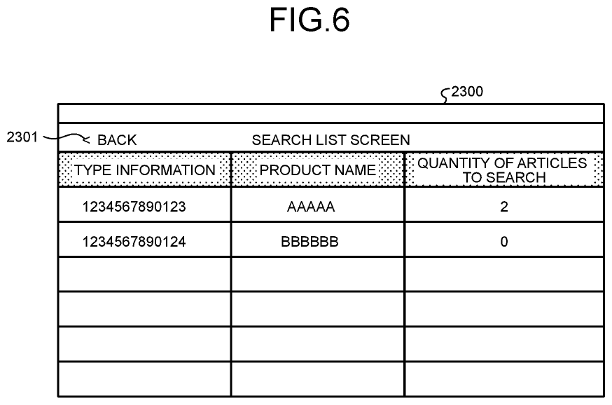

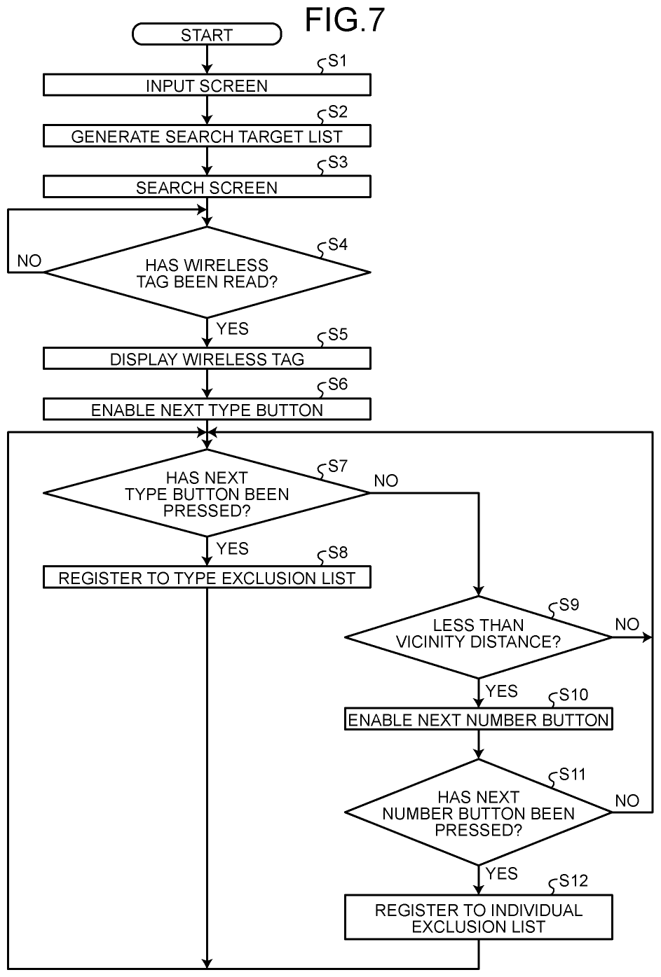

When the search list button 2205 is pressed, the display control unit 2004 controls to display a search list screen 2300. FIG. 6 is a diagram illustrating an example of the search list screen 2300. The search list screen 2300 has a list indicating the name of the article 10 and the quantity of discovered articles for each type information received by the search target input unit 2001. That is, the display control unit 2004 controls to display the name of the article 10 specified by the type information and the quantity of wireless tags 11 excluded by the individual exclusion unit 2006 for each type information received by the search target input unit 2001. The display control unit 2004 is an example of a second display unit. The operator can grasp the search result up to the present time from the search list screen 2300. The search list screen 2300 also includes a back button 2301. The back button 2301 is a button that receives an operation of displaying the search screen 2200.

The search list generation unit 2005 generates a list of the articles 10 to which the searched wireless tag 11 is attached. More specifically, the search list generation unit 2005 generates a list including the name of the article 10 specified by the type information and the quantity of searched articles for each type information received by the search target input unit 2001. The search list generation unit 2005 acquires the name of the type information received by the search target input unit 2001 from the management server 30.

Here, when having discovered the article 10 to which the wireless tag 11 is attached, the operator excludes the wireless tag 11 attached to the discovered article 10 from the search target. The search list generation unit 2005 counts the quantity of pieces of individual information excluded from the search target for each type information, as the quantity of pieces of searched information. That is, the search list generation unit 2005 counts the number of times the next number button 2203 illustrated in FIG. 5 is pressed for each type information. In this manner, the search list generation unit 2005 generates a list of the articles 10 to which the searched wireless tag 11 is attached.

The individual exclusion unit 2006 excludes, from the display target, the wireless tag 11 whose position has been displayed by the display control unit 2004. The individual exclusion unit 2006 is an example of a first exclusion unit. More specifically, when the next number button 2203 has received the operation, the individual exclusion unit 2006 excludes the wireless tag 11 from the display target. That is, the individual exclusion unit 2006 registers the individual information read by the wireless tag reading unit 2002 in the individual exclusion list 224.

The type exclusion unit 2007 excludes, from the display target, the wireless tag 11 storing the same type information as the type information stored in the wireless tag 11 at the position displayed by the display control unit 2004. The type exclusion unit 2007 is an example of a second exclusion unit. When the next type button 2202 has received an operation, the type exclusion unit 2007 excludes the wireless tag 11 that stores the type information from the display target. That is, the type exclusion unit 2007 registers the type information read by the wireless tag reading unit 2002 in the type exclusion list 223.

Next, search processing executed by the wireless tag reading device 20 will be described. Here, FIG. 7 is a flowchart illustrating an example of search processing executed by the wireless tag reading device 20 according to the embodiment.

The display control unit 2004 displays an input screen 2100 for inputting type information indicating the type of the article 10 as a search target (step S1).

The search target input unit 2001 generates the search target list 222 having one or more pieces of type information input on the input screen 2100 (step S2).

The display control unit 2004 displays the search screen 2200 for searching for the wireless tag 11 that stores the type information included in the search target list 222 (step S3).

The wireless tag reading unit 2002 determines whether the wireless tag 11 storing the type information included in the search target list 222 has been read (step S4). When the wireless tag 11 storing the type information included in the search target list 222 has not been read (step S4; No), the wireless tag reading unit 2002 waits at step S4.

When the wireless tag 11 storing the type information included in the search target list 222 has been read (step S4; Yes), the display control unit 2004 displays the position of the wireless tag 11 in the position display area 2210 (step S5).

The display control unit 2004 enables the next type button 2202 (step S6). That is, the display control unit 2004 displays the next type button 2202 as a selectable button.

The display control unit 2004 determines whether the next type button 2202 has been pressed (step S7).

When the next type button 2202 has been pressed (step S7; Yes), the type exclusion unit 2007 registers, in the type exclusion list 223, the type information stored in the wireless tag 11 as a display target of the position display area 2210 (step S8).

When the next type button 2202 has not been pressed (step S7; No), the display control unit 2004 determines whether the distance from the wireless tag reading device 20 to the wireless tag 11 is less than the vicinity distance (step S9). When the distance is not less than the vicinity distance (step S9; No), the wireless tag reading device 20 proceeds to step S7.

When the vicinity distance is less than the vicinity distance (step S9; Yes), the display control unit 2004 enables the next number button 2203 (step S10). That is, the display control unit 2004 displays the next number button 2203 as a selectable button.

The display control unit 2004 determines whether the next number button 2203 has been pressed (step S11). When the next number button 2203 has not been pressed (step S11; No), the wireless tag reading device 20 proceeds to step S7.

When the next number button 2203 has been pressed (step S11; Yes), the individual exclusion unit 2006 registers the individual information stored in the wireless tag 11 as a display target of the position display area 2210, in the individual exclusion list 224 (step S12).

Thereafter, the management server 30 proceeds to step S7.

As described above, the wireless tag reading device 20 according to the present embodiment receives an input of type information indicating the type of the article 10 as a search target. The wireless tag reading device 20 reads the wireless tag 11 storing type information. Based on the radio wave transmitted from the wireless tag 11, the wireless tag reading device 20 displays the position of the wireless tag 11 storing the type information. Subsequently, the wireless tag reading device 20 excludes the wireless tag 11 indicating the position from the display target. That is, the wireless tag reading device 20 excludes the wireless tag 11 discovered by the operator by displaying the position from the display target, and displays another piece of the wireless tag 11 storing the type information. With this configuration, the wireless tag reading device 20 displays another wireless tag 11 that stores the input type information even with no input of the identification information of each search target. This makes it possible to eliminate the need to input individual identification information of the search target, enabling the wireless tag reading device 20 to reduce the time and effort required for searching for the article 10 using the wireless tag 11. Moreover, the wireless tag reading device 20 registers the read wireless tag 11 in the type exclusion list 223 or the individual exclusion list 224. The wireless tag reading device 20 excludes the wireless tag 11 registered in the type exclusion list 223 or the individual exclusion list 224 from the display target, and displays another wireless tag 11 that stores the type information.

Although some embodiments of the present invention have been described, these embodiments have been presented as examples, and are not intended to limit the scope of the invention. These novel embodiments can be implemented in various other forms, and various omissions, substitutions, and alterations can be made without departing from the scope and spirit of the invention. These embodiments and their modifications are included in the scope and spirit of the invention, and are included in the invention described in the claims and the equivalent scope thereof.

Although the program executed by each device of the above embodiment and modification is provided by being incorporated in advance in a storage medium (ROM or storage unit) included in each device, provision of the program is not limited thereto. For example, the program may be provided in a file in an installable format or an executable format, which is recorded in a computer-readable recording medium such as CD-ROM, a flexible disk (FD), a CD-R, or a digital versatile disk (DVD). Furthermore, the storage medium is not limited to a medium independent of a computer or an embedded system, and includes a storage medium storing or temporarily storing downloaded programs transmitted via a local area network (LAN), the Internet, or the like.

In addition, the program executed by each device of the above-described embodiments and modifications may be stored on a computer connected to a network such as the Internet and provided by being downloaded via the network, or may be provided or distributed via the network such as the Internet.

The following are supplementary notes to the present invention.

### (Supplementary Note 1)

A wireless tag reading device including:
an input unit that receives one or a plurality of pieces of type information indicating a type of an article as a search target;
a reading unit that reads a wireless tag storing the type information;
a first display unit that displays a position of the wireless tag storing the type information same as the type information received by the input unit based on a result of reading the wireless tag by the reading unit; and
a first exclusion unit that excludes the wireless tag whose position has been displayed by the first display unit from a display target.

### (Supplementary Note 2)

The wireless tag reading device according to supplementary note 1, further including
a first operation unit that receives an operation of excluding the wireless tag from the display target when a distance to the wireless tag at a position displayed by the first display unit is less than a threshold,
in which, when the first operation unit has received an operation, the first exclusion unit excludes the wireless tag from the display target.

### (Supplementary Note 3)

The wireless tag reading device according to supplementary note 1 or 2, further including
a second exclusion unit that excludes, from the display target, the wireless tag storing the type information same as the type information stored in the wireless tag at the position displayed by the first display unit.

### (Supplementary Note 4)

The wireless tag reading device according to supplementary note 3, further including
a second operation unit that receives an operation of excluding, from the display target, the wireless tag storing the type information same as the type information stored in the wireless tag when the first display unit has displayed the position of the wireless tag,
in which, when the second operation unit has received an operation, the second exclusion unit excludes the wireless tag storing the type information from the display target.

### (Supplementary Note 5)

The wireless tag reading device according to any one of supplementary notes 1 to 4,
in which the reading unit reads the wireless tag storing the type information and individual information identifying the article,
the first exclusion unit registers the individual information read by the reading unit, and
the first display unit does not display the position of the wireless tag storing the individual information registered by the first exclusion unit.

### (Supplementary Note 6)

The wireless tag reading device according to any one of supplementary notes 1 to 5, further including
a second display unit that displays a name of the article specified by the type information and a quantity of the wireless tags excluded by the first exclusion unit for each of the type information received by the input unit.

### (Supplementary Note 7)

The wireless tag reading device according to any one of supplementary notes 1 to 6, further including
an estimation unit that estimates a position where the wireless tag is disposed based on a reading result of the wireless tag by the reading unit,
in which the first display unit displays the position of the wireless tag based on a result of estimation by the estimation unit.

### (Supplementary Note 8)

The wireless tag reading device according to supplementary note 7,
in which the first display unit displays a first mark indicating a position of the wireless tag reading device and a second mark indicating the position of the wireless tag based on a direction and a distance in which the wireless tag is disposed estimated by the estimation unit.

### (Supplementary Note 9)

The wireless tag reading device according to claim 8,
in which the first display unit displays the type information read from the wireless tag at the position of the second mark.

### (Supplementary Note 10)

The wireless tag reading device according to claim 8,
in which the first display unit displays individual information for identifying the article, read from the wireless tag at the position of the second mark.

### (Supplementary Note 11)

The wireless tag reading device according to any one of supplementary notes 1 to 10,
in which the first display unit displays a position of the wireless tag having a highest field intensity of a radio wave received from the wireless tag among the wireless tags read by the reading unit.

### (Supplementary Note 12)

The wireless tag reading device according to any one of supplementary notes 1 to 11,
in which, when the distance to the wireless tag is less than a threshold, the first display unit displays a first operation unit that receives an operation of excluding the wireless tag from the display target.

### (Supplementary Note 13)

The wireless tag reading device according to supplementary note 12,
in which the first operation unit is a first button that receives an operation of changing the wireless tag as a display target of the first display unit to another piece of the wireless tag.

### (Supplementary Note 14)

The wireless tag reading device according to any one of supplementary notes 1 to 13,
in which the first display unit displays a second operation unit that receives an operation of excluding, from the display target, the wireless tag storing the type information same as the type information stored in the wireless tag when the position of the wireless tag has been displayed.

### (Supplementary Note 15)

The wireless tag reading device according to supplementary note 14,
in which the second operation unit is a second button that receives an operation of changing individual information for identifying the article to which the wireless tag being the display target of the first display unit is attached, to another piece of the individual information.

### (Supplementary Note 16)

The wireless tag reading device according to any one of supplementary notes 1 to 15, further including
a third display unit that displays an input screen, the input screen including: an input field for inputting the type information of the search target; an add button for adding the type information input in the input field as the search target, and a display field for displaying the added type information.

### (Supplementary Note 17)

The wireless tag reading device according to any one of supplementary notes 1 to 16, further including
an antenna that transmits and receives radio waves to and from the plurality of wireless tags,
in which the wireless tag reading unit reads the wireless tag by decoding the radio wave received by the antenna.

### (Supplementary Note 18)

A control method being a method of controlling a wireless tag reading device, the method including:
receiving one or a plurality of pieces of type information indicating a type of an article as a search target;
reading a wireless tag storing the type information;
displaying a position of the wireless tag storing the type information same as the received type information based on a reading result of the wireless tag; and
excluding the wireless tag whose position has been displayed, from a display target.

The wireless tag reading device 20 described in supplementary note 1 excludes the wireless tag 11 registered in the type exclusion list 223 or the individual exclusion list 224 from the display target and displays another piece of the wireless tag 11 storing the type information. With this configuration, the wireless tag reading device 20 does not display the searched wireless tag 11, making it possible to reduce the time and effort required for searching for the article 10 using the wireless tag 11.

The wireless tag reading device 20 described in supplementary note 2 receives an operation of excluding the wireless tag 11 from the display target when the distance to the wireless tag is less than a threshold. With this operation, the wireless tag reading device 20 can prevent exclusion of the wireless tag 11 being searched, from the display target.

The wireless tag reading device 20 described in supplementary note 3 excludes the wireless tag 11 storing the type information from the display target. This makes it possible for the wireless tag reading device 20 to set the wireless tag 11 storing a different type of type information as the display target.

The wireless tag reading device 20 described in supplementary note 4 excludes the wireless tag 11 storing the same type information as the type information stored in the displayed wireless tag 11 from the display target, when the position of the wireless tag has been displayed. This makes it possible for the wireless tag reading device 20 to change the search target to the wireless tag 11 of another type information.

The wireless tag reading device 20 described in supplementary note 5 registers the individual information read from the wireless tag 11, and does not display the position of the registered wireless tag 11. With this configuration, the wireless tag reading device 20 does not display the position of the searched wireless tag 11, making it possible to reduce the time and effort required for searching for the article 10 using the wireless tag 11.

The wireless tag reading device 20 described in supplementary note 6 displays the name of the article specified by the type information and the quantity of wireless tags 11 excluded. This makes it possible for the wireless tag reading device 20 to display the quantity of excluded wireless tags 11, that is, the quantity of searched wireless tags 11.

The wireless tag reading device 20 described in supplementary note 7 estimates the position of the wireless tag 11 and displays the estimated position of the wireless tag 11. With this configuration, the wireless tag reading device 20 displays the position of the wireless tag 11, making it possible to reduce the time and effort required for searching for the article 10 using the wireless tag 11.

The wireless tag reading device 20 described in supplementary note 8 displays a first mark indicating the position of the wireless tag reading device 20 being a subject device and a second mark indicating the position of the wireless tag 11. This makes it possible to search for the article 10 while comparing the position of the wireless tag 11 with the position of the subject device, making it possible for the wireless tag reading device 20 to reduce the time and effort required for searching for the article 10 using the wireless tag 11.

The wireless tag reading device 20 described in supplementary note 9 displays the type information read from the wireless tag 11. This makes it possible for the wireless tag reading device 20 to allow the user to grasp the type of the article being searched.

The wireless tag reading device 20 described in supplementary note 10 displays individual information for identifying the article 10 to which the wireless tag 11 is attached. This makes it possible for the wireless tag reading device 20 to allow the user to grasp the article being searched.

The wireless tag reading device 20 described in supplementary note 11 displays the position of the wireless tag 11 having the highest field intensity of the radio wave received from the wireless tag 11. This makes it possible for the wireless tag reading device 20 to display the position of the wireless tag 11 having the highest field intensity, that is, the position of the nearest wireless tag 11.

The wireless tag reading device 20 described in the supplementary note 12 displays a first operation unit that receives an operation of excluding the wireless tag 11 from the display target when the distance to the wireless tag 11 is less than a threshold. With this operation, when the distance to the wireless tag 11 is less than the threshold, the operation of excluding the wireless tag 11 from the display target is received, making it possible for the wireless tag reading device 20 to prevent exclusion of the wireless tag 11 being searched from the display target.

The wireless tag reading device 20 described in supplementary note 13 receives an operation of changing to another wireless tag 11 by the first button. This makes it possible for the wireless tag reading device 20 to change to another piece of the wireless tag 11 by pressing the first button.

When displaying the position of the wireless tag 11, the wireless tag reading device 20 described in supplementary note 14 receives an operation of excluding the wireless tag 11 storing the same type information as the type information stored in the displayed wireless tag 11 from the display target. This makes it possible for the wireless tag reading device 20 to change the search target to the wireless tag 11 of another type information.

The wireless tag reading device 20 described in supplementary note 15 receives an operation of changing to another piece of the wireless tag 11 using the second button. This makes it possible for the wireless tag reading device 20 to change the search target to the wireless tag 11 of another type information by pressing the second button.

The wireless tag reading device 20 described in supplementary note 16 displays an input screen. This makes it possible for the wireless tag reading device 20 to receive the type information of the search target on the input screen.

The wireless tag reading device 20 described in supplementary note 17 transmits and receives a radio wave for reading the wireless tag 11 with the antenna 241. This makes it possible for the wireless tag reading device 20 to read the wireless tag 11.

The control method, being a method of controlling the wireless tag reading device 20 described in supplementary note 18, excludes the wireless tag 11 registered in the type exclusion list 223 or the individual exclusion list 224 from the display target and displays another piece of the wireless tag 11 storing the type information. With this configuration, the control method does not display the searched wireless tag 11, making it possible to reduce the time and effort required for searching for the article 10 using the wireless tag 11.

What is claimed is:

1. A wireless tag reading device comprising a processor, wherein the processor is configured to:
receive one or more pieces of type information, each indicating a type of an article as a search target;
read, from a wireless tag storing a piece of type information, the piece of type information;
display a position of the wireless tag when the piece of type information read is identical to any of the one or more pieces of type information received; and
exclude the wireless tag whose position has been displayed from a display target.

2. The wireless tag reading device according to claim 1, further comprising
a first operation unit that receives an operation of excluding the wireless tag from the display target when a distance to the displayed position of the wireless tag is less than a threshold,
wherein, when the first operation unit receives the operation, the processor is configured to exclude the wireless tag from the display target when the distance to the displayed position of the wireless tag is less than the threshold.

3. The wireless tag reading device according to claim 1, wherein the processor is configured to exclude the wireless tag from the display target when the piece of type information read is identical to a piece of type information stored in another wireless tag whose position has been displayed.

4. The wireless tag reading device according to claim 3, further comprising
a second operation unit that receives an operation of excluding, from the display target, another wireless tag storing a piece of type information identical to the piece of type information stored in the wireless tag when the position of the wireless tag is displayed,
wherein, when the second operation unit receives the operation, the processor is configured to exclude the another wireless tag storing the identical piece of type information from the display target.

5. The wireless tag reading device according to claim 1, wherein the processor is configured to
read, from the wireless tag storing the piece of type information and a piece of individual information identifying an article, the piece of type information and the piece of individual information,
register the piece of individual information read, and
set the position of the wireless tag storing the piece of the individual information registered non-displayed.

6. The wireless tag reading device according to claim 1, wherein the processor is configured to display, for each piece of the type information received, a name of the article specified by the piece of type information and a quantity of one or more wireless tags excluded from the display target.

7. A computer-readable storage medium storing a program that causes a processor of a wireless tag reading device to execute:
receiving one or more pieces of type information, each indicating a type of an article as a search target;
reading, from a wireless tag storing a piece of type information, the piece of type information;
displaying a position of the wireless tag when the piece of type information read is identical to any of the one or more pieces of type information received; and
excluding the wireless tag whose position has been displayed from a display target.
